(19) United States
(12) Patent Application Publication
(10) Pub. No.: US 2018/0236707 A1
(43) Pub. Date: Aug. 23, 2018

(54) STRETCH BLOW MOLDING MACHINE DIFFERENT ARTICLES FROM THE SAME PREFORMS IN A SINGLE CYCLE

(71) Applicant: W. AMSLER EQUIPMENT INC., Richmond Hill (CA)

(72) Inventors: Werner AMSLER, Mount Albert (CA); Mei LI, Markham (CA)

(21) Appl. No.: 15/898,480

(22) Filed: Feb. 17, 2018

Related U.S. Application Data
(60) Provisional application No. 62/460,228, filed on Feb. 17, 2017.

(51) Int. Cl. B29C 49/64; B29C 49/48

(52) U.S. Cl. CPC B29C 49/6418; B29C 2049/4871; B29C 49/48

(57) ABSTRACT

A molding machine configured to simultaneously produce differently shaped articles in a blow molding operation in which similar or identical preforms are used for making each of the differently shaped articles.

### BACKGROUND

Stretch Blow Molding Machines are used to reheat thermoplastic preforms and stretch blow mold them into finished articles such as bottles and other containers.

Known examples of such machines include that disclosed U.S. Pat. No. 5,876,768, entitled “Machines for the Production of Receptacles of Plastic Material,” which teaches a reheat stretch blow molding machine having a track for pallets, each carrying two preforms. The pallets pass through an oven arrangement having three parallel paths with heaters arranged between the paths such that three pallets at a time enter and exit the oven. The heaters are mounted to a frame that is suspended above the pallets and can be moved vertically upward to disengage the heaters from the matrix of preforms to prevent damaging them in the event of a machine stoppage. Three pallets at a time enter the 6 cavity blow mold for blowing the articles. There is no teaching of individually conditioning the preforms in the various pallet tracks.

U.S. Pat. No. 4,963,086, entitled “Reheat Blow Molding Machine for Forming Articles from Preforms,” teaches loading four preforms onto a pallet which is moved transversely through an oven. The oven is configured to have four lanes so that multiple pallets pass through the oven and each of their preforms travels along a different one of the four parallel paths. Heaters and reflectors are arranged between the paths. All the preforms from one pallet are loaded into a four cavity blow mold for blowing the finished articles. There is no teaching of individually conditioning the preforms in the various pallet tracks.

U.S. Pat. No. 7,220,378, entitled “Method and Apparatus for the Measurement and Control of Both the Inside and Outside Surface Temperature of Thermoplastic Preforms During Stretch Blow Molding Operations,” teaches using a high speed infrared sensor to measure the surface temperature of a preform as it exits the oven on its way to the blow mold and using that measurement to control the thermal conditioning of upstream preforms.

U.S. Pat. No. 6,514,448, entitled “Device for Tempering Preforms and Tempering Method,” teaches differentially heating strip-shaped regions of the preform along its length so that oval, triangular or rectangular cross section blown articles can be made. There is no teaching of individually conditioning the preforms in multiple pallet tracks.

U.S. Pat. No. 6,287,507, entitled “Process for Temperature-Control of Preforms and Temperature-Control Device,” teaches a preform being conditioned to have a temperature profile in striplike regions extending longitudinally so that articles having non-round cross sections can be blow molded. There is no teaching of individually conditioning the preforms in multiple pallet tracks.

U.S. Pat. No. 5,292,243, entitled “Apparatus for Heating Portions of Container Preforms,” teaches temperature conditioning a preform with a non-symmetrical temperature distribution about its longitudinal axis to allow the blow molding of a non-symmetrical article that has “an essentially uniform wall thickness distribution.” There is no teaching of individually conditioning the preforms in multiple pallet tracks.

U.S. Pat. No. 6,555,033, entitled “Method and Apparatus for Making a Plastic Container and Closure Combination,” teaches a family mold, used in an extrusion blow molding process, “capable of simultaneously receiving a pair of extruded parisons. One of the parisons is utilized to produce a pair of aligned container bodies and the other of the parisons is utilized to form a pair of aligned closures.” There is no teaching of individually conditioning the preforms in multiple pallet tracks.

U.S. Pat. No. 5,433,916, entitled “Utilizing Multi Cavity Mold in Extrusion Blow Molding Process,” teaches a rotary extrusion blow molding machine having molds containing two different mold cavities in each whereby the movable extruder head feeds a parison to each of the different mold cavities sequentially to form two different parts from each mold. There is no teaching of individually conditioning the preforms in multiple pallet tracks.

Additional known techniques include those described in U.S. Pat. No. 4,571,173, U.S. 6,368,099B1, U.S. Pat. No. 7,097,446B2, U.S. Pat. No. 7,291,811B2, US 2007/0042074A1, US 2012/0326345A1, WO 01/34369A1, and WO 03/018293A1.

### SUMMARY OF THE INVENTION

According to one aspect of the invention, separate lines of a preform are individually conditioned to be stretch blow molded in a multi-cavity blow mold such that each blow mold cavity produces a different article from substantially the same preform.

### BRIEF DESCRIPTION OF THE DRAWINGS

The drawings illustrate, by way of example only, embodiments of the present invention.

FIG. 1 is a schematic view of the front of a machine.

FIG. 2 is a photograph of preforms entering the conditioning area.

FIG. 3 is a photograph of preforms exiting the conditioning area.

FIG. 4 is a schematic view of the stretch blow molding clamp.

FIG. 5 is a diagram of a multi-cavity blow mold.

FIG. 6 is a diagram of individually height-adjustable heater assemblies.

FIG. 7 is a photograph of an oven height adjustment mechanism.

### DETAILED DESCRIPTION OF THE INVENTION

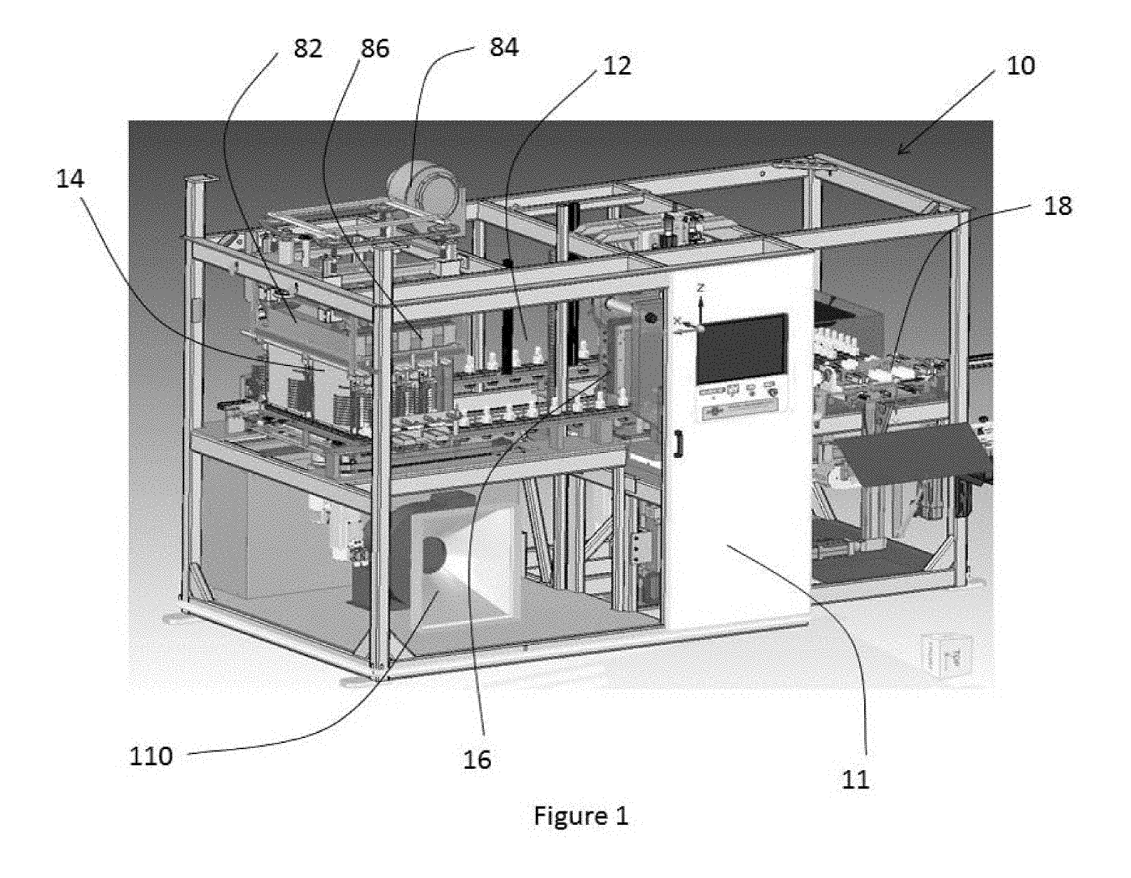

FIG. 1 shows a reheat stretch blow molding machine 10 comprising a preform loading area 12, a preform conditioning area 14, a stretch blow molding clamp 16, an unloading area 18, and a control interface 11. Each preform is loaded onto a rotatable mandrel mounted on a pallet at the loading area 12. The pallets are moved via a series of tracks through the different areas of the machine in paths, both single and multiple, namely loading, conditioning, blow molding, and unloading to provide a continuous process wherein each preform is conditioned and formed into a final article.

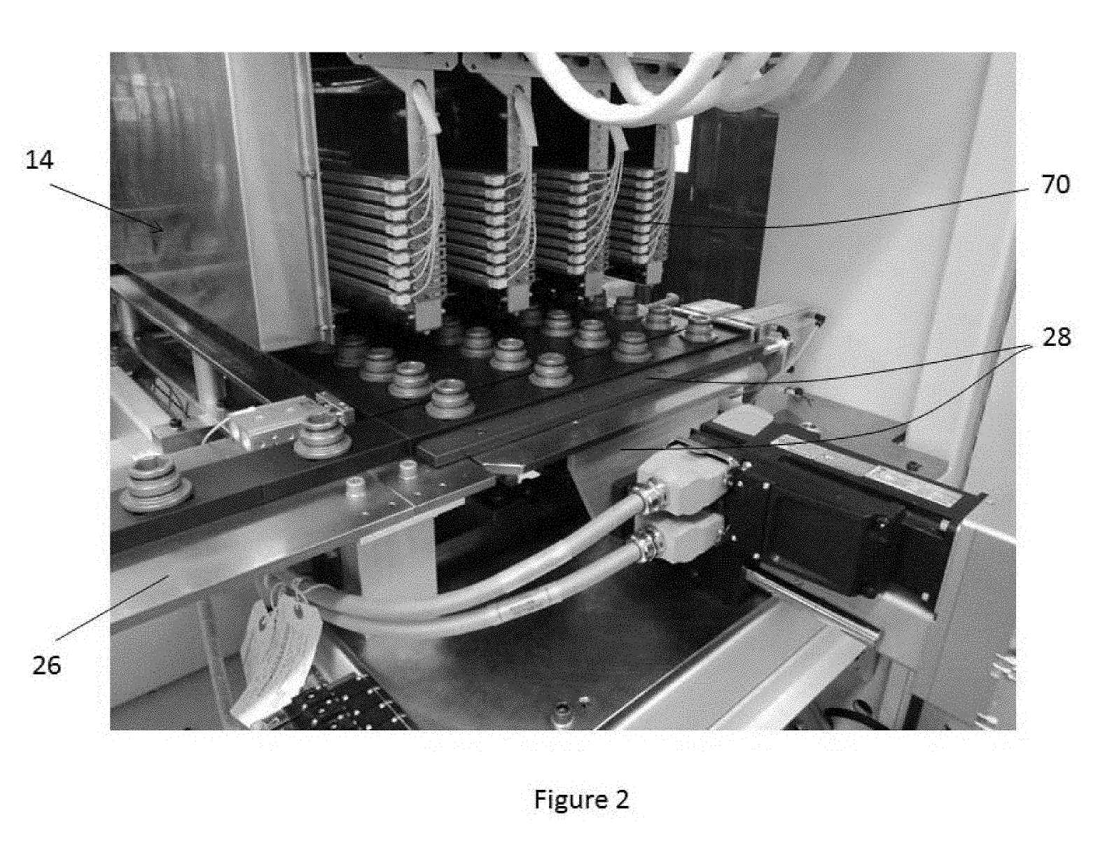

FIG. 2 show the preform conditioning area 14 that comprises four parallel paths for pallets to pass through thereby conditioning four lines of preforms simultaneously prior to the entry of preforms from each line into the stretch blow molding operation. While this embodiment shows a four-path arrangement through the conditioning area 14, different numbers of parallel paths could also be used to provide an optimum configuration for a particular machine.

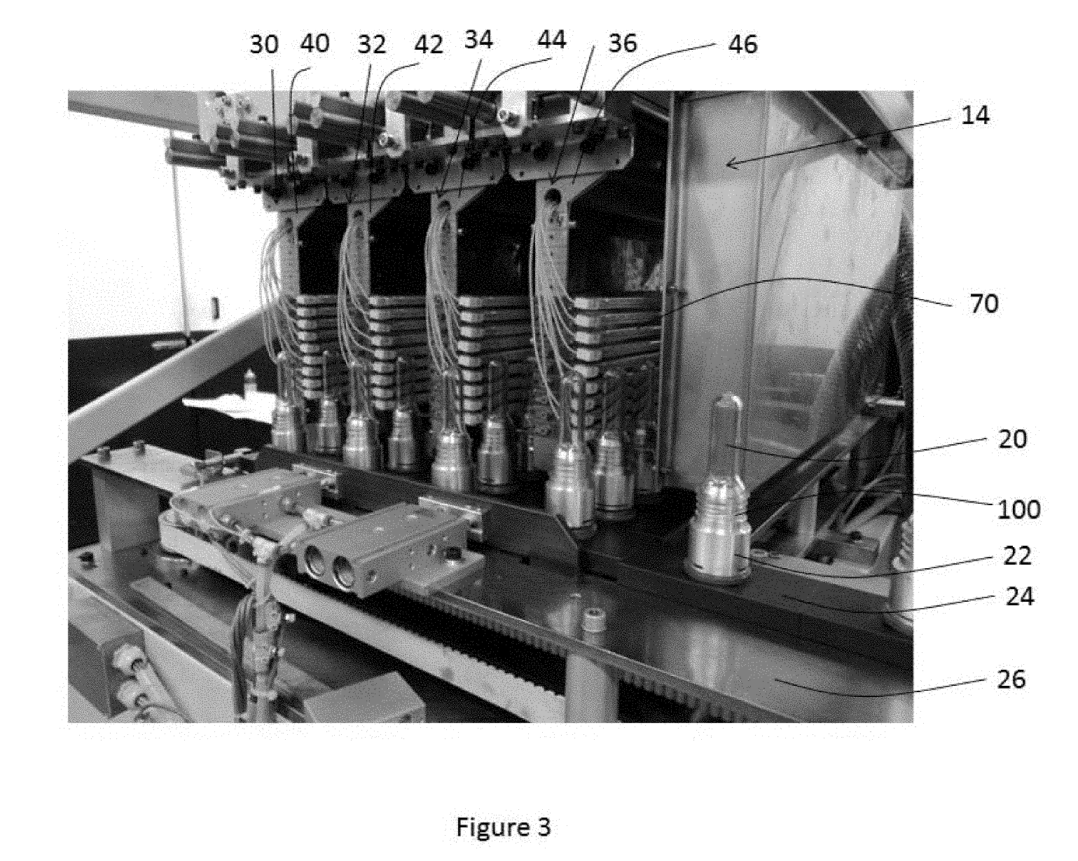

FIG. 3 also shows a preform 20, mounted on a mandrel 22 that is rotatably mounted on a pallet 24. The mandrels can be changed to accommodate various preform neck finish diameters. FIG. 2 shows the pallets are entrained in track 26 and are aligned for entry into the conditioning area 14. Pushing mechanism 28 moves four pallets simultaneously into one each of four parallel tracks through the conditioning area 14. Thus, four rows of preforms are conditioned simultaneously as they pass through the conditioning area 14.

FIG. 3 shows the conditioning area 14 comprises four parallel rows of heater assemblies 30, 32, 34 and 36 respectively, each assembly including a heater support structure 40, 42, 44 and 46 respectively. Multiple heaters 70 are mounted on each heater support structure to enable heating of the preforms 20 while they are rotated on their mandrels 22 as they pass through the conditioning area 14.

FIG. 3 shows the conditioned preforms 20 exiting the conditioning area 14. Thereafter they are moved in groups of four into the stretch blow molding area 16 where they are blow molded into final articles.

The conditioning area 14 also includes an air handling system 82 (see FIG. 1) mounted above the heater support structures and configured to move air between the parallel rows of preforms and heaters during the conditioning process. The air handling system 82 includes a blower 110 and a fan 84, a venting and ducting configuration 86 that moves air across the surfaces of the rotating preforms during their heating process.

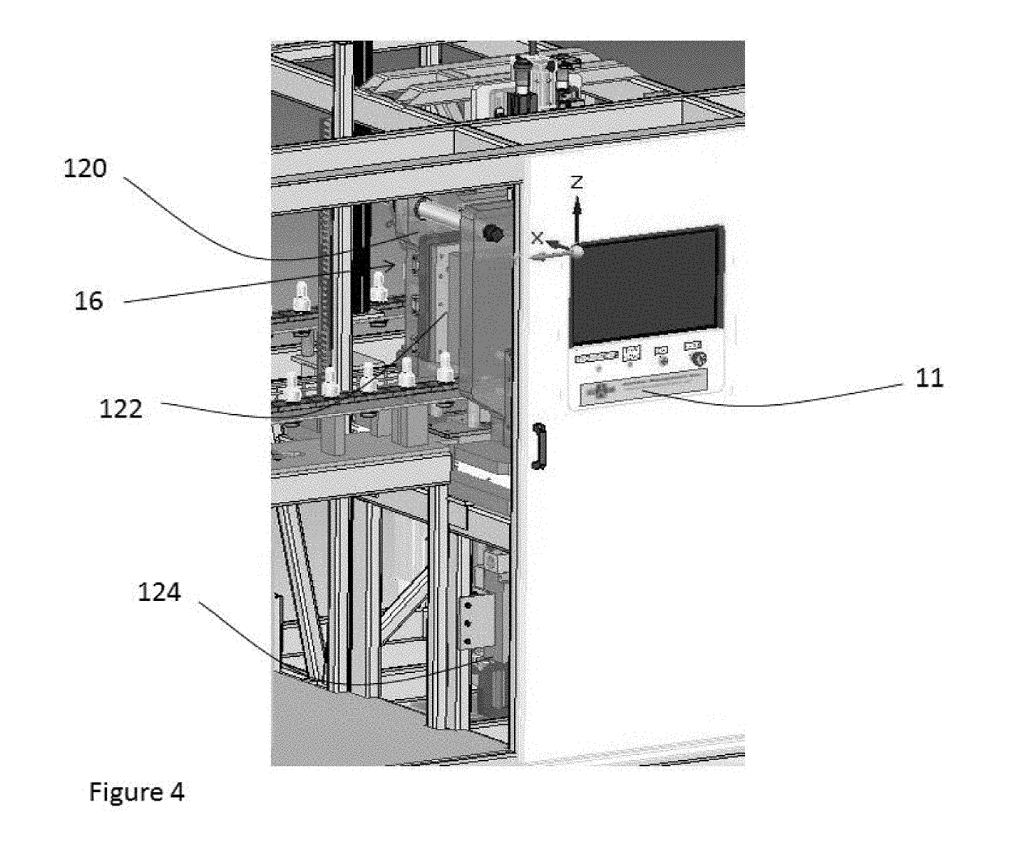

FIG. 4 shows the stretch blow molding area 16 mounted behind the operator interface 11. The stretch blow molding area 16 includes a horizontal blow clamp 120 operated by an electric motor. The blow clamp supports and operates a blow mold 122 and a stretch rod assembly 124, operated by one or more servo motors, to raise and lower stretch rods inside the conditioned preforms during the stretch blow molding process.

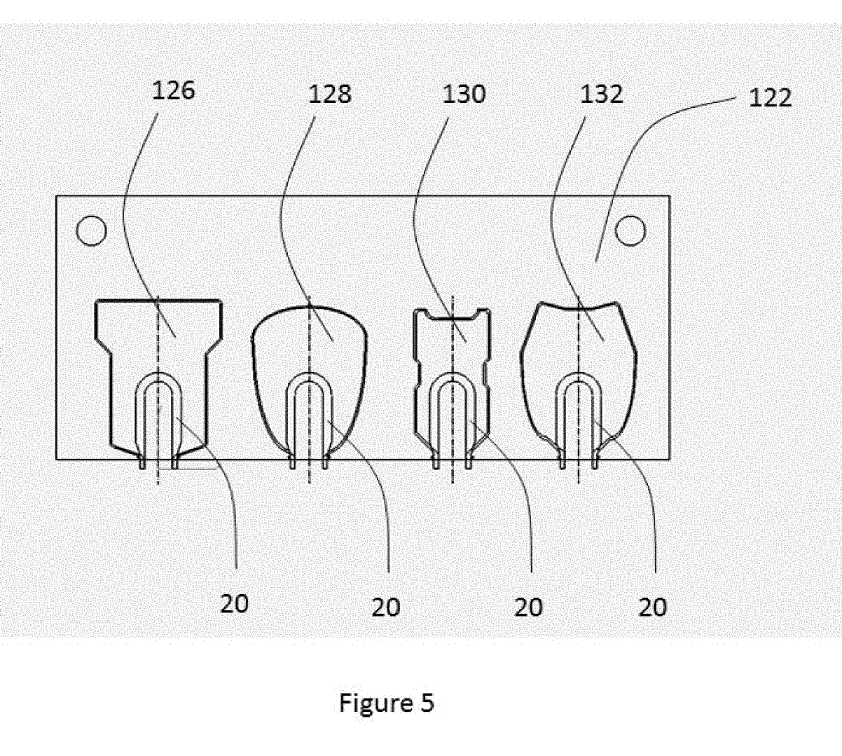

FIG. 5 shows a four cavity blow mold 122 that is installed in the blow clamp 120. Each of the four cavities accommodates one conditioned preform 20. In this example four identical preforms 20 are shown, however, each has been conditioned differently in the conditioning area 14. The four blow mold cavities 126, 128, 130 and 132 are different in shape and consequently when the preforms are stretch blow molded and conform to these respective shapes four differently shaped articles are produced by the blow mold in one blow molding operational cycle. Base plugs, inserts and other blow mold features typically used in these operations have been omitted for simplification but are included in the concept of this invention. Also the blow mold configuration is not limited to a four cavity layout, different numbers of cavities are also included in the concept of this invention.

The individual conditioning of the preforms 20 in each of the four lines is effected in the conditioning area 14 by customizing the heat profiling of the preforms as they pass through the ovens along one of the four parallel paths. Individually customizing the heat profiling can be achieved by control of rotation profiles of mandrels (e.g., mandrel speed, variability in mandrel speed so as to heat different regions of the preform differently, etc.), control of heater settings, control of air flow over the preforms, and similar.

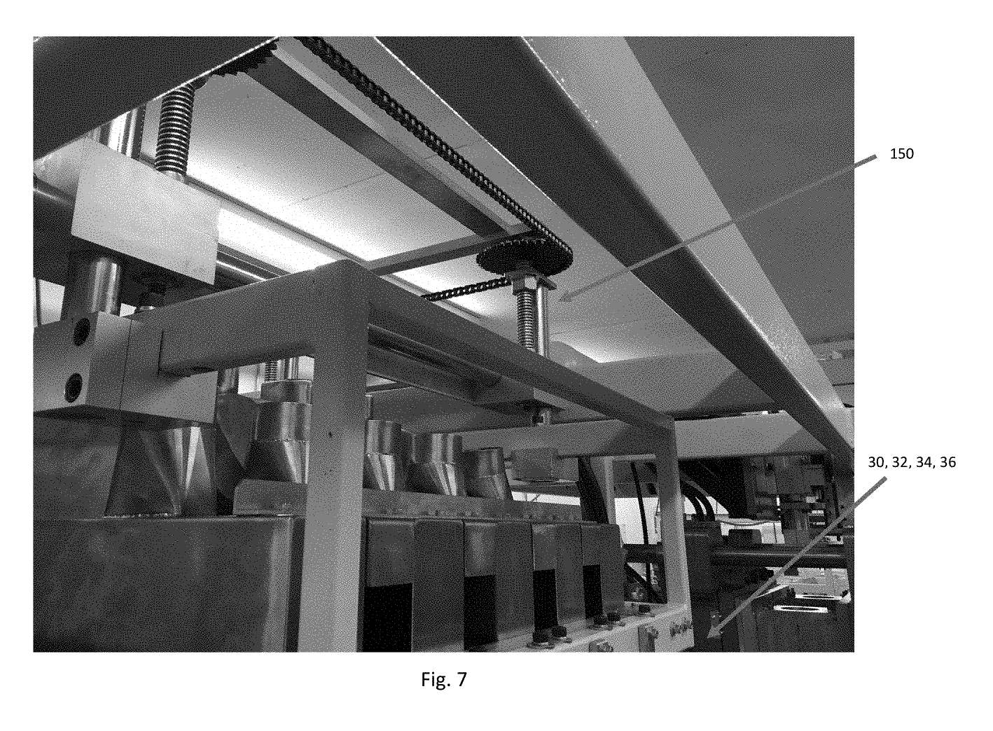

In the present embodiment, the oven assembly, which includes the heater assemblies 30, 32, 34, 36, is configured to be vertically adjustable in position as a unit. This is shown FIG. 7, which illustrates a mechanism, including a linear actuator 150, for raising and lowering the heater assemblies 30, 32, 34, 36 at the same time. Setting the vertical position of the oven assembly allows for proper alignment of heat input into the preforms of all paths. This allows, among other things, accommodation for different preform and mandrel dimensions.

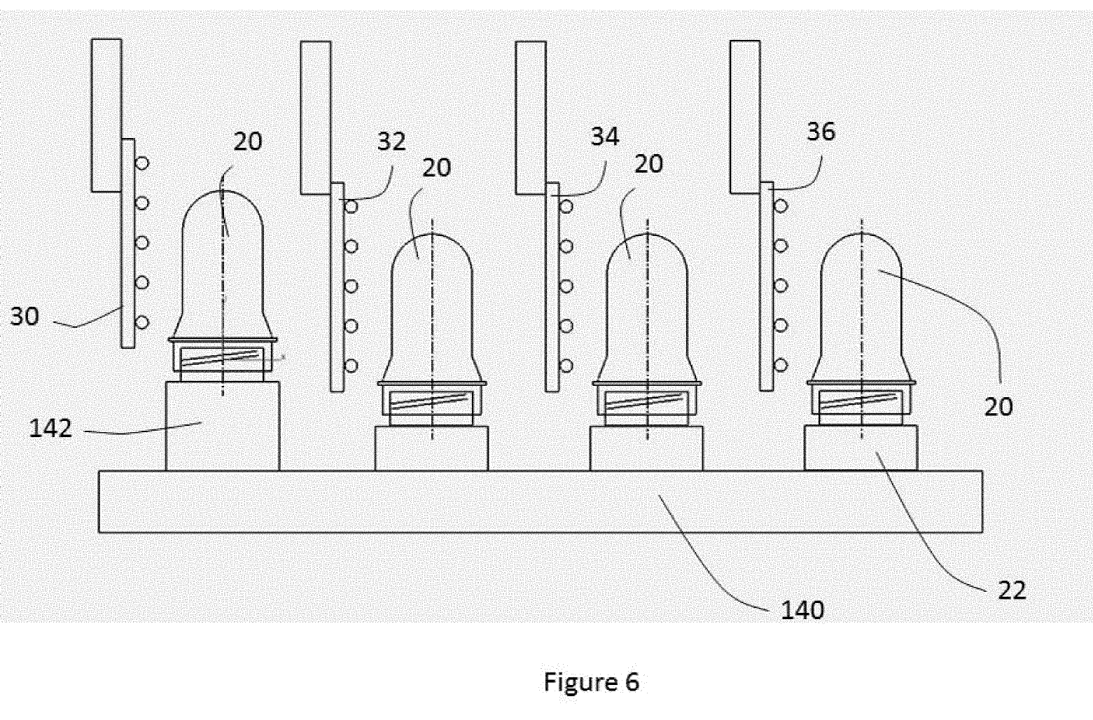

In alternative embodiments, each heater assembly 30, 32, 34, 36 is configured to be individually vertically adjustable in position, as shown in FIG. 6. This allows for further customization of heat provide on a line-by-line basis. That is, the heater assembly 30, 32, 34, 36 for each path can be vertically positioned in a way that is optimal for the respective path. This is useful, for example, if cavity size/shape requires mandrels of different heights. For instance, a particular cavity may require a different vertical position for the preform. A pallet 140 is provided with multiple mandrels, one or more of which is a mandrel 142 of height different from the other mandrels 20 (e.g., a taller mandrel, in the depicted example). The pallet 140 enforces the relative position of the mandrels 20, 142, so that the preform positioning matches with the cavities, and each heater assembly 30, 32, 34, 36 is individually vertically positioned to accommodate the respective mandrel 20, 142. In the example shown, the heater assembly 30 is raised to provide suitable heat input into the path of preforms with the taller mandrel 142.

During the stretch blow molding process each of the four stretch rods may be individually programmed to operate according to the recipe developed for blow molding the specific shape of the cavity it is serving. Similarly, the supply of the blowing fluid into the preform during the operation may be individually synchronized and profiled according to the recipe developed for blow molding the specific shape of the cavity it is serving. Accordingly, four different articles are stretch blow molded from four identical preforms during a single blow molding cycle. Clearly not all the mold cavities have to be different, two or three of them could be the same depending on the quantities of similar shaped articles required.

The present invention therefore advantageously allows for production runs of greater efficiency and greater customizability. For example, if two bottles of different shape are to be molded and one shape is required in a greater quantity, a four-cavity mold can be configured to, in each cycle, mold three bottles of the higher-demand shape and one bottle of the lower-demand shape. The conditioning provided by the conditioning area 14 can be configured accordingly, with the three lines of preforms corresponding to the three bottles of the higher-demand shape being conditioned optimally for that specific shape and with the one line of preforms corresponding to the one bottle of the lower-demand shape being conditioned differently and optimally for that particular shape. Moreover, these advantages are achieved using substantially identical preforms.

While the foregoing provides certain non-limiting examples, it should be understood that combinations, subsets, and variations of the foregoing are contemplated. The monopoly sought is defined by the claims.

What is claimed is:

1. A molding machine configured to simultaneously produce differently shaped articles in a blow molding operation in which similar or identical preforms are used for making each of the differently shaped articles.

2. A process comprising individually conditioning different lines of preforms using a multi-path conditioning area and performing a blow molding operation on preforms of the different lines of preforms.

3. A multi-cavity blow mold having differently shaped mold cavities.

4. A stretch blow molding process comprising individually conditioning preforms of substantially the same shape and molding the preforms into differently shaped finished articles.

5. A molding machine having a multi-path conditioning area in which heater assemblies of each path are individually vertically adjustable.

6. The molding machine of claim 5, further comprising mandrels of different heights.

7. The molding machine of claim 6, further comprising at least one pallet to which are attached mandrels of different heights.
